(19) United States
(12) Patent Application Publication
(10) Pub. No.: US 2023/0401913 A1
(43) Pub. Date: Dec. 14, 2023

(54) ACCESS CONTROL DEVICE AND SYSTEM

(71) Applicant: DORMAKABA SCHWEIZ AG, Rümlang (CH)

(72) Inventors: Paul STUDERUS, Oberweningen (CH); André LÜSCHER, Meilen (CH)

(21) Appl. No.: 18/250,342

(22) PCT Filed: Oct. 25, 2021
(86) PCT No.: PCT/EP2021/079545

§ 371 Date: Apr. 24, 2023

(30) Foreign Application Priority Data
Oct. 26, 2020 (CH) 01372/20

(51) Int. Cl. G07C 9/00

(52) U.S. Cl. CPC G07C 9/00309; G07C 2209/63; G07C 2009/00555; G07C 2209/04

(57) ABSTRACT

An access control device for controlling access within a secure control area by means of barriers having associated security perimeters. The access control device comprises ultra-wideband transceiver(s) configured to execute ultra-wideband transmission(s) with one or more authentication device(s) and a processing unit. The processing unit is configured to: determine physical location(s) of the authentication device(s) within the secure control area by processing signal properties of the ultra-wideband transmission(s) and determine the security perimeter(s) where the authentication device(s) is/are located based on the physical location(s). The access control device is configured to execute an access control process(s) with respect to the barrier(s) associated with the security perimeter(s) where the authentication device(s) is/are located.

### FIELD OF THE INVENTION

The present invention relates to an access control device, a security control system, and a method for controlling access within a secure control area. Furthermore, the present invention relates to a computer program product comprising computer-executable instructions which, when executed by a processing unit of an access control device, causes the access control device to carry out the method for controlling access.

### BACKGROUND OF THE INVENTION

Keyless entry systems have become widely used in applications in particular for access control in building facilities. Access control relates to granting, denying or limiting access to particular section(s) of a secure controlled area, usually by means of some level of access control by use of a barrier, such as a door, turnstile, parking gate, elevator door, or other barrier.

Keyless entry systems operate in that an access control device executes a wireless communication with an authentication device, such as a keyless fob, a keycard or an authentication device incorporating a corresponding wireless transceiver. Once said wireless communication between the access control device and the authentication device has been executed, the access control device exchanges data messages with the authentication device. The authentication can be initiated either by a user, for instance by pressing a button on the authentication device to trigger transmission of authentication data to the access control device, or from the access control device itself which periodically transmits request signals and awaits a response message from the authentication device comprising authentication data. Upon successful authentication, i.e. verification of user credentials (e.g. by correlating authentication data received from the authentication device with a list of authorized users), the access control device grants access to the user in possession of the respective authentication device, e.g. by opening said barrier. On the other hand, if the authentication fails, the access control device denies access to the user in possession of the respective authentication device, e.g. by locking the barrier/by keeping the barrier locked.

For close-range applications, a radio-frequency identification (RFID) transponder (or tag) is often used, which has mostly replaced earlier magnetic stripe cards. Other current solutions use infra-red systems or radio systems to transmit an authenticating signal from an authentication device to an access control device of a security control system. Close-proximity keyless systems, (i.e. between direct contact and a threshold of a few centimeters), for example RFID based systems, allow determination of a user's proximity to a barrier by appropriate placement of a reader device of the access control device. However, as their name implies close-proximity keyless systems suffer from the is disadvantage that they require a very close proximity of the authentication device to the access control device. In order to overcome this disadvantage, mid-range keyless entry systems have been proposed, in particular based on ultra-wideband UWB communication. Ultra-wideband UWB systems are advantageous since they allow reliable mid-range communication without a user having to precisely identify the reader device. As the communicating range between an authentication device and an access control device increases, the convenience and ease-of-use increases, because the authentication device does not need to be placed in very close range, such as less than one centimeter from the access control device. The user no longer needing to precisely locate the access control device (or its antenna) not only adds convenience but also has the potential to speed up the process, thereby increasing the throughput through a barrier.

In known security control systems with more than one barrier, an access control device is dedicated to each barrier and configured to control the barrier such as to grant or deny access in accordance with a user presenting a corresponding authentication device. It is essential that each access control device (dedicated to a particular barrier) is able to ensure under all circumstances that it authenticates—and thereby grants, limits or denies access—users in the proximity of the barrier they are dedicated to. In other words, cross-talk between access control devices dedicated to different barriers is to be avoided. In order to fulfill this requirement—unquestionable association of an access control device with a particular barrier—according to known security control systems, access control devices are installed in the close proximity of each barrier (such as directly on a door, right beside a door, or integrated into turnstiles, etc.).

However, installing an access control device in the close proximity of each barrier is associated with considerable installation effort and hence cost. Often, installing an access control device in the close proximity of each barrier requires cabling and other infrastructure being installed. Alternatively, access control devices are known which are battery operated. However, monitoring battery capacity—to ensure that battery operated access control devices are functional—is a complex, time consuming and error-prone task in security control systems with a high number of barriers. Furthermore, even if cabling effort is saved using battery operated access control devices, there is still some degree of installation effort required. This effort is even more aggravated when barriers need to be secured after their installation, often requiring closing down areas around such barriers and possibly dismantling of existing infrastructure. Such additional installation burden makes known security control systems—relying on access control devices installed in the close proximity of each barrier—inflexible, i.e. extension and/or reconfiguration of barriers within an existing security control system is only possible with considerable amount of effort.

### SUMMARY OF THE INVENTION

It is an object of embodiments disclosed herein to provide an access control device, a security control system, and a computer implemented method for controlling access within a secure control area that overcome one or more of the disadvantages of known access control devices, security control systems and of known methods for access control of access control devices/systems.

In particular, it is an object of embodiments disclosed herein to provide an access control device, a security control system, and a computer implemented method for controlling access within a secure control area that significantly reduce the installation efforts/costs associated with providing access control to barrier(s) of a security control system.

According to embodiments of the present disclosure, the above-mentioned objects are addressed by an access control device for controlling access within a secure control area by means of one or more barriers, one or more security perimeters being associated with the one or more barriers. The access control device comprises one or more ultra-wideband transceiver(s) and a processing unit. The one or more ultra-wideband transceiver(s) are configured to execute one or more ultra-wideband transmission(s) with one or more authentication device(s). The processing unit is configured to determine physical location(s) of the authentication device(s) within the secure control area by processing signal properties of the one or more ultra-wideband transmission(s). The physical location(s) of the authentication device(s) is determined in particular as 2-dimensional or 3-dimensional location(s), in particular as 2-dimensional or 3-dimensional coordinate(s) within the secure control area.

According to embodiments of the present disclosure, the access control device is configured to determine the physical location(s) of the authentication device(s) within the secure control area by multilateration and/or multiangulation using the plurality of ultra-wideband transmissions, in particular by a plurality of UWB antennae of the ultra-wideband transceiver(s) of the access control device.

Determining the distance between the access control device and the authentication devices by processing signal properties of ultra-wideband UWB transmissions is particularly advantageous since it allows a reliable and precise determination of the distance(s).

Determining a distance based on the propagation time of an ultra-wideband transmission comprises measuring the time required for a signal to travel from the ultra-wideband transceiver to the ultra-wideband communication module of the authentication device and/or the time required for a signal to travel from the authentication device to the ultra-wideband transceiver. In a particular embodiment, a time difference is used as a basis for determining the distance, as it is more secure against spoofing attacks, wherein a third party may use a radio relay device to gain unauthorized access to a location or system in a so-called “relay-attack”. Depending on the embodiment, the time difference is a “one-way time-of-flight” time difference between the ultra-wideband transceiver sending the request value and the authentication device receiving the request value, or a “round-trip time-of-flight” time difference, in which a second transmission takes place from the authentication device to the ultra-wideband transceiver either prior to, or after the first transmission of the request value. In the “one-way time-of-flight” scenario, the ultra-wide-band transceiver and the authentication device need to be provided with tightly synchronized clocks for accurately determining the distance. In the latter case of a “round-trip time-of-flight” calculation, there is stored, either in the authentication device or the ultra-wideband transceiver, an accurate representation of the processing time, i.e. the time it takes between the reception of an ultra-wideband transmission and the sending of a response ultra-wideband transmission, which processing time allows for accurately determining the distance. Measurement of a time required for the signal to travel from the ultra-wideband transceiver to the authentication device and back “round-trip time-of-flight” is advantageous as it does not require the precise synchronization of clock signals of the ultra-wideband transceiver and the authentication device.

Determining a distance based on amplitude difference, comprises determining the difference in signal amplitude between the signal transmitted by the ultra-wideband transceiver and the signal received by the authentication device (or vice-versa). By taking into consideration the attenuation of the signal, the distance between the ultra-wideband transceiver and the authentication device is calculated.

Determining a distance based on phase difference comprises detecting the difference in signal phase between the signal transmitted by the ultra-wideband transceiver and the signal received by the authentication device. By taking into consideration the change in signal phase, the distance between the ultra-wideband transceiver and the authentication device is determined. It is to be understood that for the amplitude difference and phase difference, alternatively, the signal may also be transmitted by the authentication device and received by the ultra-wideband transceiver.

The processing unit is further configured to determine the security perimeter(s) where the authentication device(s) is/are located based on the physical location(s).

Having determined in which security perimeter(s) the authentication device(s) is/are located, the access control device is configured to execute an access control process(s) with respect to the barrier(s) associated with the security perimeter(s) where the authentication device(s) is/are located.

Controlling access within a secure control area using the access control device according to the present invention is particularly advantageous as the installation efforts/costs associated with providing access control to existing barrier(s) of a security control system are significantly reduced. Since the access control device of the present invention does not need to be located in immediate proximity of the barrier, there is no longer a need for effort-intensive installation of cabling to each barrier. Furthermore, extending the access control to additional barrier(s) merely requires defining additional security perimeter(s).

Furthermore, according to embodiments of the present disclosure, the above-mentioned objects are particularly addressed by a computer implemented method for controlling access within a secure control area by means of one or more barriers communicatively connected to an access control device, one or more security perimeters being associated with the one or more barriers. In a first step of the method, one or more ultra-wideband transmission(s) are executed with one or more authentication device(s) using one or more ultra-wideband transceiver(s) of the access control device. In a subsequent step, physical location(s) of the authentication device(s) within the secure control area is/are determined by processing signal properties of the one or more ultra-wideband transmission(s). Thereafter, the security perimeter(s) where the authentication device(s) is/are located is/are determined based on the physical location(s). Having determined in which security perimeter(s) the authentication device(s) is/are located, an access control process(s) is executed with respect to the barrier(s) associated with the security perimeter(s) where the authentication device(s) is/are located.

Furthermore, according to embodiments of the present disclosure, the above-mentioned objects are particularly addressed by a computer program product comprising computer-executable instructions which, when executed by a processing unit of an access control device, causes the access control device to carry out the method for controlling access according to one of the embodiments disclosed herein.

Furthermore, according to embodiments of the present disclosure, the above-mentioned objects are particularly addressed by a security control system comprising an access control device according to one of the embodiments disclosed herein and one or more barriers arranged within a secure control area, one or more security perimeters being associated with the one or more barriers.

According to embodiments of the present disclosure, the access control device is arranged and configured for controlling access within a secure control area by means of more than one (i.e. a plurality of) barriers, a plurality of security perimeters being associated with the plurality of barriers. Accordingly, the processing unit is configured to identify the barrier(s) from the plurality of barriers associated with the security perimeter(s) where the authentication device(s) is/are located.

As multiple barriers share the same access control device, the costs associated with the access control device are reduced by a factor as high as the number of barriers the access control device is configured to control.

According to embodiments of the present disclosure, executing an access control process(s) comprises: receiving authentication data from the authentication device(s); verifying the authentication data in order to determine whether the authentication device(s) is/are authorized for access through the barrier(s) associated with the security perimeter(s) where the authentication device(s) is/are located; and—if the authentication device(s) is/are authorized—granting access using the barrier(s) associated with the security perimeter(s) where the authentication device(s) is/are located.

It is an object of further embodiments of embodiments of the present disclosure to provide an access control device, a security control system, and a computer implemented method for controlling access within a secure control area that is able to prevent accidentally/inadvertently granting access to holders of an authentication device, e.g. for holders merely passing by barrier(s) of the secure control area. According to embodiments of the present disclosure, the above-mentioned object of further embodiments is particularly addressed in that access is only granted upon receipt of a trigger signal from a trigger control associated with the respective barrier(s), such as touching or actuating a door handle. Alternatively, or additionally, accidental/inadvertent grant of access to holders of an authentication device, e.g. for holders merely passing by barrier(s) of the secure control area, is prevented by embodiments disclosed herein by granting access only after the one or more ultra-wideband transmission(s) with an authentication device has been maintained for longer than a threshold time period.

It is an object of further embodiments of the present disclosure to provide an access control device, a security control system, and a computer implemented method for controlling access within a secure control area that is able to prevent accidentally/inadvertently granting access to users having a first type authorization and at the same time provide an increased level of convenience for users of a second type authorization. For example, it is desirable to prevent accidentally/inadvertently granting access to an administrator of a secure control area—who is frequently present in multiple security perimeters without the intention to gain access through each and every barrier, while at the same time providing convenience for guests/regular users—who have a clear intention to gain access through the barrier they are approaching. According to the present invention, the above-mentioned object of further embodiments is particularly addressed in that the access control device is configured to distinguish, based on the authentication data, between a first-type and a second-type authorization. In order to avoid accidental/inadvertent grant of access to an administrator of a secure control area—who is frequently present in multiple security perimeters without the intention to gain access through each and every barrier, i.e. the authorization is of the first-type, access is granted only upon receipt of a trigger signal from a trigger control associated with the respective barrier(s). In order to provide convenience for guests/regular users—who have a clear intention to gain access through the barrier they are approaching, access is granted immediately (i.e. without further user interaction) if the authorization is of the second-type, irrespective of a trigger signal being received or not.

Alternatively, or additionally, security and convenience are both provided according to embodiments of the present disclosure by associating a first security perimeter and a second security perimeter with each of the one or more barriers. In particular, the first security perimeter is smaller than a second security perimeter. In order to avoid accidental/inadvertent grant of access to an administrator of a secure control area—who is frequently present in multiple security perimeters without the intention to gain access through each and every barrier, if the authorization is of the first-type, access is granted using the barrier(s) associated with first (smaller) security perimeter(s) where the authentication device(s) is/are located. In order to provide convenience for guests/regular users—who have a clear intention to gain access through the barrier they are approaching—if the authorization is of the second-type, access is granted using the barrier(s) associated with second security perimeter(s) where the authentication device(s) is/are located. In simple words, accidental/inadvertent grant of access is prevented by reducing the security perimeter for users who are frequently present in multiple security perimeters without the intention to gain access through each and every barrier while convenience is provided by a larger security perimeter.

It is an object of further embodiments of the present disclosure to provide an access control device, a security control system, and a computer implemented method for controlling access within a secure control area that is able to provide an increased level of security. In order to address particular uses cases (such as a bank vault), it is desirable to ensure that at least two authorized users are present within a particular security perimeter before access is granted through a barrier. According to the present invention, this use case is addressed in that the access control device is further configured to execute the access control process only if a first authentication device is within the same security perimeter as a second authentication device, both first authentication device and second authentication device being authorized to access through the barrier(s) associated with the security perimeter(s) where the authentication device(s) is/are located.

In order to address a further particular uses case (such as a crowded environment), it is desirable to ensure that only one user is present within a particular security perimeter before access is granted through a barrier. According to the present invention, this use case (referred to as anti-tailgating) is addressed in that the access control device is configured to deny, disregard and/or block authentication requests if the first authentication device is within the same security perimeter as the second authentication device.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings in which:

FIG. 1: shows a highly schematic top view of a first embodiment of the security control system according to the present invention;

FIG. 2: shows a schematic block diagram of a first embodiment of an access control device according to the present invention;

FIG. 3: shows a highly schematic top view of a further embodiment of the security control system according to the present invention, comprising a plurality of barriers having a plurality of security perimeters associated thereto;

FIG. 4A-4B: show a flow chart illustrating a sequence of steps of a first embodiment of a computer implemented method for controlling access within a secure control area according to the present invention;

FIG. 5: shows a flow chart illustrating a sequence of steps of a further embodiment of a computer implemented method for controlling access within a secure control area according to the present invention, wherein access is granted only upon receipt of a trigger signal from a trigger control;

FIG. 6: shows a flow chart illustrating a sequence of steps of a further embodiment of a computer implemented method for controlling access within a secure control area according to the present invention, wherein a first-type and a second-type authorization is distinguished based on authentication data and access is granted only upon receipt of a trigger signal from a trigger control if the authorization is of the first-type while access is granted immediately if the authorization is of the second-type;

FIG. 7: shows a flow chart illustrating a sequence of steps of a further embodiment of a computer implemented method for controlling access within a secure control area according to the present invention, wherein—in order to implement a four-eyes security policy—access is granted only if two authorized authentication devices are located within the respective security perimeter;

FIG. 8: shows a flow chart illustrating a sequence of steps of a further embodiment of a computer implemented method for controlling access within a secure control area according to the present invention, wherein—in order to prevent so-called tailgating—access is only granted if no other authentication device is located within the respective security perimeter;

FIG. 9: shows a highly schematic top view of a further embodiment of the security control system according to the present invention, comprising a plurality of barriers, wherein a first security perimeter and a second security perimeter are associated with each of the barriers;

FIG. 10: shows a flow chart illustrating a sequence of steps of a further embodiment of a computer implemented method for controlling access within a secure control area according to the present invention, wherein multiple security perimeters are associated with each of the barriers, different levels of access rights being associated with the multiple security perimeters;

FIG. 11: shows a highly schematic top view of a security control system according to the present invention as deployed in a secure control area having a plurality of barriers, security perimeters being associated with the one or more barriers; and

FIG. 12: shows a highly schematic perspective view of a security control system according to the present invention as deployed in a secure control area having a plurality of barriers, security perimeters being associated with the one or more barriers.

### DETAILED DESCRIPTION OF EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

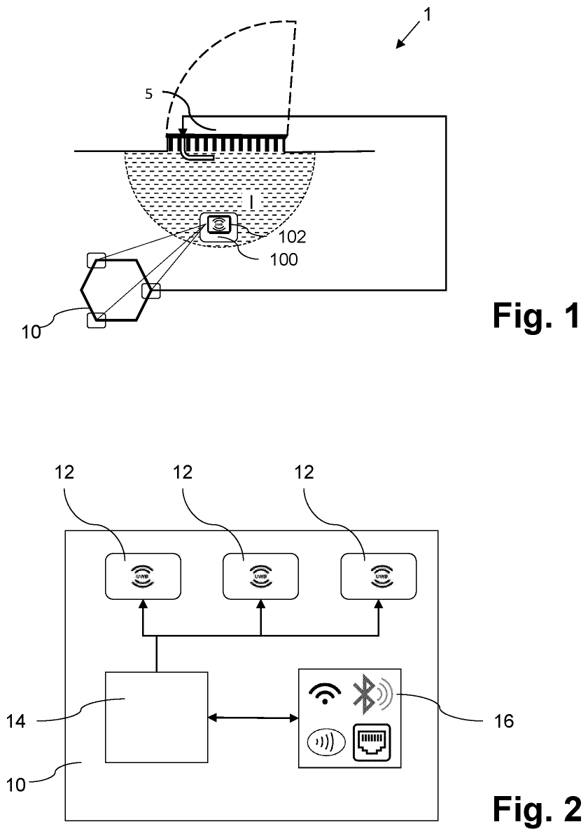

FIG. 1 shows a highly schematic top view of a first embodiment of the security control system 1 according to the present invention. The security control system 1 comprises an access control device 10 and a barrier 5 arranged within a secure control area A, the barrier 5 being communicatively connected to the access control device 10. The barrier 5 may be such as a door, turnstile, parking gate, elevator door, or other barrier. Furthermore, the barrier 5 must not be a physical barrier preventing access, but may—according to embodiments of the present disclosure—also comprise indication means such as audible (such as a siren which is activated if passage is detected despite access not being granted) and or visual means (such as a traffic light).

The secure control area A may be an entrance area of a building, a hallway, a control section of an airport or the like. At least one security perimeter I is associated with the barrier 5. As illustrated, the access control device 10 may be located remote from the barrier 5 and/or from the security perimeter I. According to embodiments of the present disclosure, the security perimeter I is defined on one or both sides of the barrier 5.

In the figures, reference numeral 100 refers to an authentication device. The authentication device 100 is a portable electronic system such as a smart phone, smart watch, tablet, laptop, or similar device. The authentication device 100 contains a processor (not shown) and an ultra-wideband communication module 102. The ultra-wideband communication module 102 is configured for establishing an ultra-wideband transmission with an access control device 10 of the security control system 1. According to further embodiments disclosed herein, the authentication device 100 further comprises a wireless communication module for data transmission to a respective interface of the communication module 16 of the access control device 10 using an alternative communication technology (as compared to UWB) such as Bluetooth Low Energy (BLE), a Wireless Local Area Network (WLAN), ZigBee, Radio Frequency Identification (RFID), Z-Wave, and/or Near Field Communication (NFC). According to further embodiments disclosed herein, the authentication device 100 also contains provisions for wired communication via a socket such as USB, Micro-USB, USB-C, Lightning, or 3.5 mm jack, for use in a wired communication using an appropriate protocol for wired transmission.

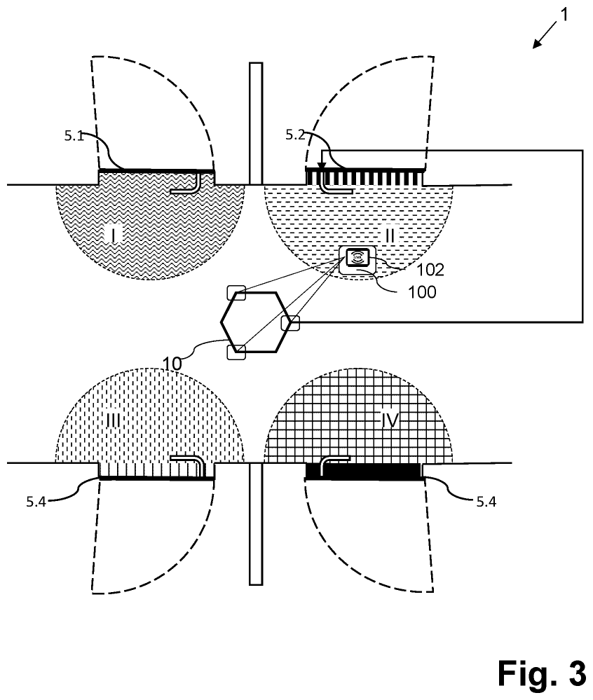

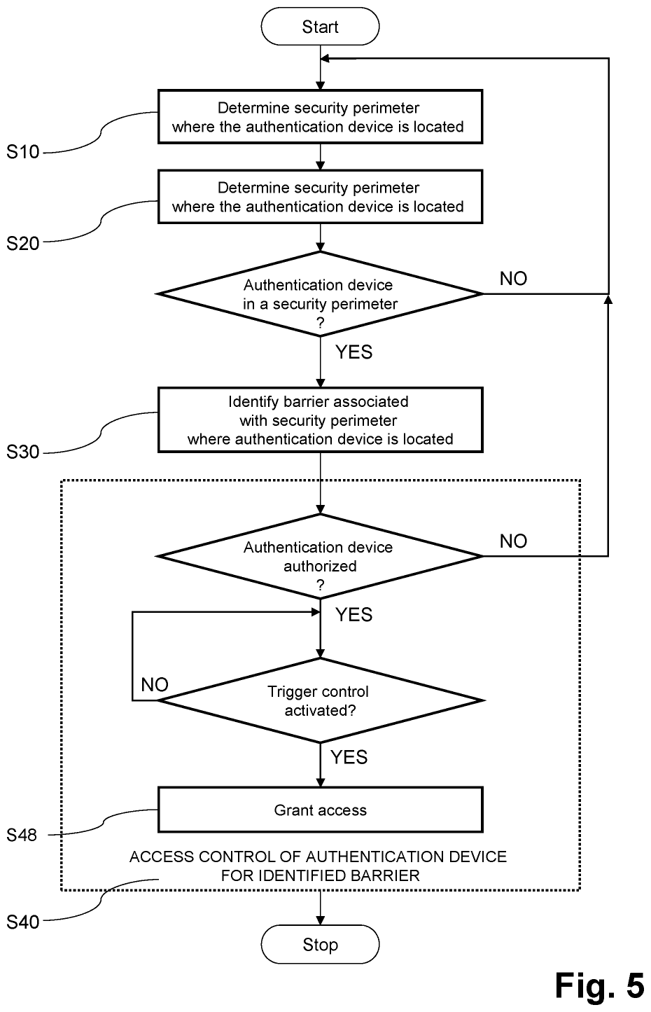

FIG. 2 shows a schematic block diagram of a first embodiment of an access control device 10 according to the present invention, comprising a plurality of ultra-wideband transceiver(s) 12 and a processing unit 14. The processing unit 14 shall be described in detail with respect to its function in relation with the flowcharts of FIGS. 5 to 10.

The ultra-wideband transceivers 12 are configured to execute ultra-wideband transmissions with authentication device(s) 100. The processing unit 14 is configured to determine the physical location(s) of the authentication device(s) 100 within the secure control area A by processing signal properties of the ultra-wideband transmissions. The physical location(s) of the authentication device(s) 100, 100′ is determined in particular as 2-dimensional or 3-dimensional location(s), in particular as 2-dimensional or 3-dimensional coordinate(s), within the secure control area A.

The access control device 10 is configured to determine the physical location(s) of the authentication device(s) 100 within the secure control area A by multilateration and/or multiangulation using the plurality of ultra-wideband transmissions by the plurality of ultra-wideband transceiver(s) 12 of the access control device 10. Multilateration and/or multiangulation relies on determining the distances between the authentication device(s) 100 and the plurality of ultra-wideband transceiver(s) 12 of the access control device 10. Determining the distances between the authentication device(s) 100 and the plurality of ultra-wideband transceiver(s) 12 based on the propagation time of the ultra-wideband transmissions comprises measuring the time required for a signal to travel from the ultra-wideband transceivers 12 to the ultra-wideband communication module 102 of the authentication device 100; and/or the time required for a signal to travel from the ultra-wideband communication module 102 of the authentication device 100 to the ultra-wideband transceiver 12. In a particular embodiment, a time difference is used as a basis for determining the distances, as it is more secure against spoofing attacks, wherein a third party may use a radio relay device to gain unauthorized access to a location or system in a so-called “relay-attack”. Depending on the embodiment, the time difference is a “one-way time-of-flight” time difference between the ultra-wideband transceivers 12 sending a signal and the authentication device 100 receiving the signal, or a “round-trip time-of-flight” time difference, in which a second transmission takes place from the ultra-wideband communication module 102 of the authentication device 100 to the ultra-wideband transceivers 12 either prior to, or after, the first transmission of the signal. In the “one-way time-of-flight” scenario, the ultra-wide-band transceivers 12 and the ultra-wideband communication module 102 of the authentication device 100 need to be provided with tightly synchronized clocks for accurately determining the distances. In the latter case of a “round-trip time-of-flight” calculation, there is stored, either in the authentication device 100 or the ultra-wideband transceivers 12, an accurate representation of the processing time, i.e. the time it takes between the reception of an ultra-wideband transmission and the sending of a response ultra-wideband transmission, which processing time allows for accurately determining the distances. Measurement of a time required for the signal to travel from the ultra-wideband transceivers 12 to the ultra-wideband communication module 102 of the authentication device 100 and back “round-trip time-of-flight” is advantageous as it does not require the precise synchronization of clock signals of the ultra-wideband transceivers 12 and the authentication device 100.

Determining the distances between the authentication device(s) 100 and the plurality of ultra-wideband transceiver(s) 12 based on amplitude difference, comprises determining the difference in signal amplitude between the signal transmitted by the ultra-wideband transceivers 12 and the signal received by the ultra-wideband communication module 102 of the authentication device 100 (or vice-versa). By taking into consideration the attenuation of the signal, the distances are calculated.

Determining the distances between the authentication device(s) 100 and the plurality of ultra-wideband transceiver(s) 12 based on phase difference comprises detecting the difference in signal phase between the signal transmitted by the ultra-wideband transceivers 12 and the signal received by the ultra-wideband communication module 102 of the authentication device 100. By taking into consideration the change in signal phase, the distances are determined. It is to be understood that for the amplitude difference and phase difference, alternatively, the signal may also be transmitted by the ultra-wideband communication module 102 of the authentication device 100 and received by the ultra-wideband transceivers 12 of the access control device 10.

According to embodiment(s) disclosed herein, determining the distance(s) between the ultra-wideband transceivers 12 and the authentication device 100 comprises transmitting a request message to the ultra-wideband communication module 102 of the authentication device 100 and processing a response message received from the authentication device 100, referred to as control device initiated transmission. Control device transmission is advantageous as the timing respectively the frequency of the interrogation (transmitting a request message to the authentication device) is solely in the control of the access control device 10.

Alternatively, or additionally, determining the first distance between the ultra-wideband transceivers 12 and the authentication device 100 comprises receiving and processing broadcast signal from the authentication device 100, referred to as authentication device initiated transmission. Authentication device initiated transmission is advantageous since it allows the authentication device 100 to control the timing/frequency of the broadcast signal(s) (to establish the first respectively second ultra-wideband transmission), allowing the authentication device 100 to switch its respective radio communication module into a standby/low-power or off mode to thereby conserve energy.

The access control device 10 further comprises a communication module16 for establishing data communication link(s) with the authentication device(s) 100, 100′ and/or the barrier(s) 5, 5.1, 5.2, 5.3, 5.4 for receiving authentication data from the authentication device(s) 100, 100′ respectively for controlling the barrier(s) (5, 5.1, 5.2, 5.3, 5.4). According to embodiments of the present disclosure, the communication module 16 comprises wireless communication interface(s) (such as Bluetooth Low Energy BLE, a Wireless Local Area Network WLAN, Zig Bee, Radio Frequency Identification RFID, Z-Wave, and/or Near Field Communication NFC interface(s)) and/or wired communication interface(s) (such as an Ethernet interface).

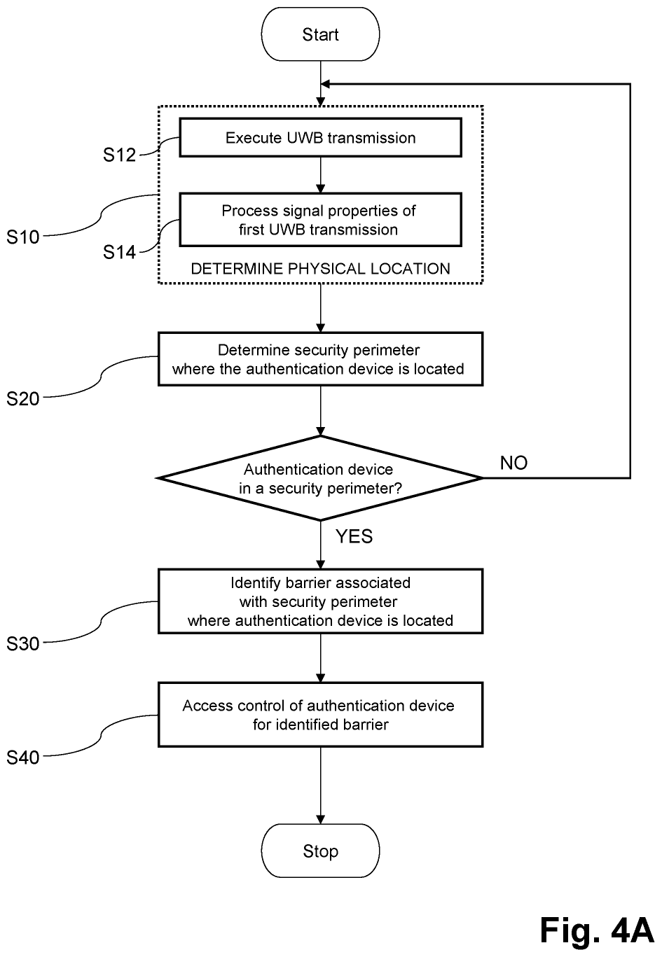

FIG. 3 shows a highly schematic top view of a further embodiment of the security control system 1 according to the present invention, comprising a plurality of barriers 5.1, 5.2, 5.3, 5.4 having a plurality of security perimeters I, II, III, IV associated thereto. The advantages of multiple barriers 5.1, 5.2, 5.3, 5.4 “sharing” a single access control device are well illustrated, dedicated access control devices 10 for each barrier 5.1, 5.2, 5.3, 5.4 not being necessary. The functionality of the security control system 1 for controlling access shall be described in following paragraphs with reference to the flowcharts.

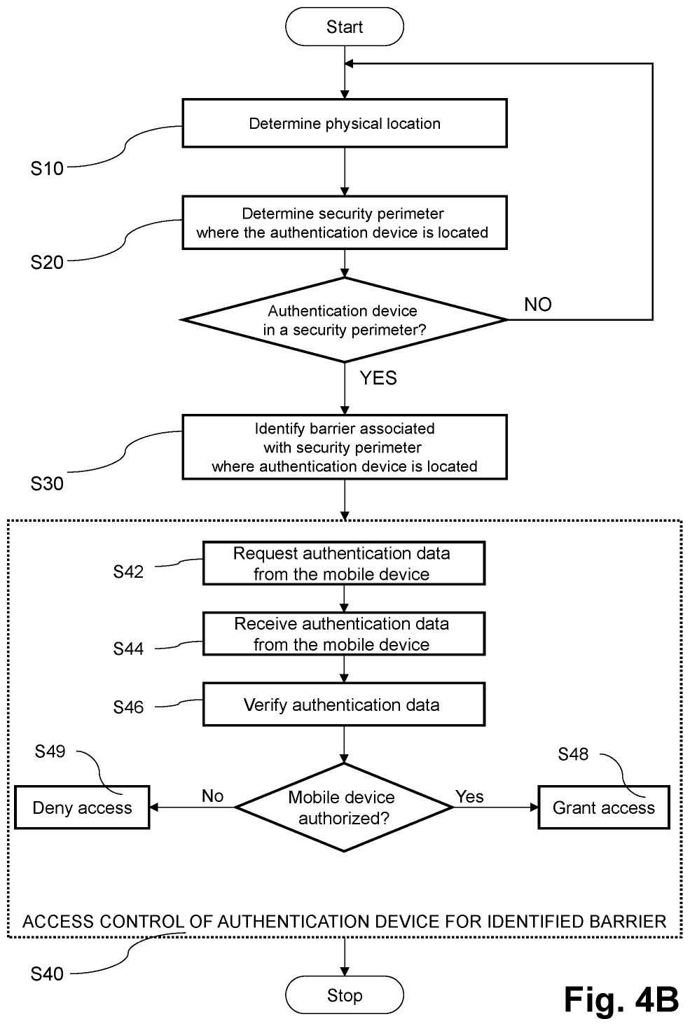

FIGS. 4A and 4B show a flow chart illustrating a sequence of steps of a first embodiment of a computer implemented method for controlling access within a secure control area A according to the present invention. In a first step S10, the physical location(s) of the authentication device(s) 100, 100′ within the secure control area A is determined. The physical location(s) of the authentication device(s) 100, 100′ is determined—in step S10—as 2-dimensional or 3-dimensional location(s), in particular as 2-dimensional or 3-dimensional coordinate(s), within the secure control area A.

In a first sub-step S12 of step S10, one or more ultra-wideband transmission(s) with one or more authentication device(s) 100, 100′ are executed using one or more ultra-wideband transceiver(s) 12 of the access control device 10. In a second sub-step S14 of step S10, signal properties of the one or more ultra-wideband transmission(s) are processed by the processing unit 14 of the access control device 10. According to embodiments of the present disclosure, sub-step S14 comprises multilateration and/or multiangulation using the plurality of ultra-wideband transmissions, in particular by a plurality of UWB antennae of the ultra-wideband transceiver(s) 12 of the access control device 10.

Having determined the physical location(s) of the authentication device(s) 100 within the secure control area A, in a subsequent step S20, the processing unit 14 determines which security perimeter I, II, III, IV the authentication device(s) 100, 100′ is/are located in. The processing unit 14 is able to determine which security perimeter I, II, III, IV the authentication device(s) 100, 100′ is/are located in further based on data indicative of the physical boundaries/layout of the plurality of security perimeters I, II, III, IV as well as data indicative of the physical location of the access control device 10 within the secure control area A.

If the authentication device 100 is located in one of the security perimeters I, II, III or IV, in an intermediary step S30, the processing unit 14 identifies the barrier(s) 5.1, 5.2, 5.3, 5.4 associated with the security perimeter(s) I, II, III, IV where the authentication device(s) 100 is located.

Thereafter, in a step S40, the access control device 10 executes an access control process(s) with respect to the barrier(s) 5.1, 5.2, 5.3, 5.4 associated with the security perimeter(s) I, II, III, IV where the authentication device(s) 100, 100′ is/are located. The wording “execute an access control process(s) with respect to a barrier” refers to performing the access control process dedicated to the particular barrier, comprising verifying whether the authentication device(s) 100 (it's user) is authorized to pass that particular barrier 5.1, 5.2, 5.3, 5.4.

As shown on FIG. 4B, step S40 of executing access control for the authentication device 100 comprises:
Sub-step S42: requesting authentication data from the authentication device 100;
Sub-step S44: receiving authentication data from the authentication device 100;
Sub-step S46: verifying said authentication data from authentication device 100 against a set of authorized users/authentication devices and/or validating a digital signature in order to determine whether the authentication device 100 (respectively its holder) is authorized for the respective barrier 5.1, 5.2, 5.3, 5.4;
Sub-step S48: if the authentication device(s) 100, 100′ is/are authorized—granting access using the barrier(s) 5.1, 5.2, 5.3, 5.4 associated with the security perimeter(s) I, II, III, IV where the authentication device(s) 100, 100′ is/are located, particularly comprising one or more of: unlocking/opening the barrier 5.1, 5.2, 5.3, 5.4; and
Sub-step S49: denying access for the holder of the authentication device 100 if the authentication device 100 not authorized, particularly comprising one or more of: closing/locking the barrier 5.1, 5.2, 5.3, 5.4.

FIG. 5 shows a flow chart illustrating a sequence of steps of a further embodiment of a computer implemented method for controlling access within a secure control area A according to the present invention, wherein access is granted only upon receipt of a trigger signal from a trigger control 7, 7.1, 7.2, 7.3, 7.4.

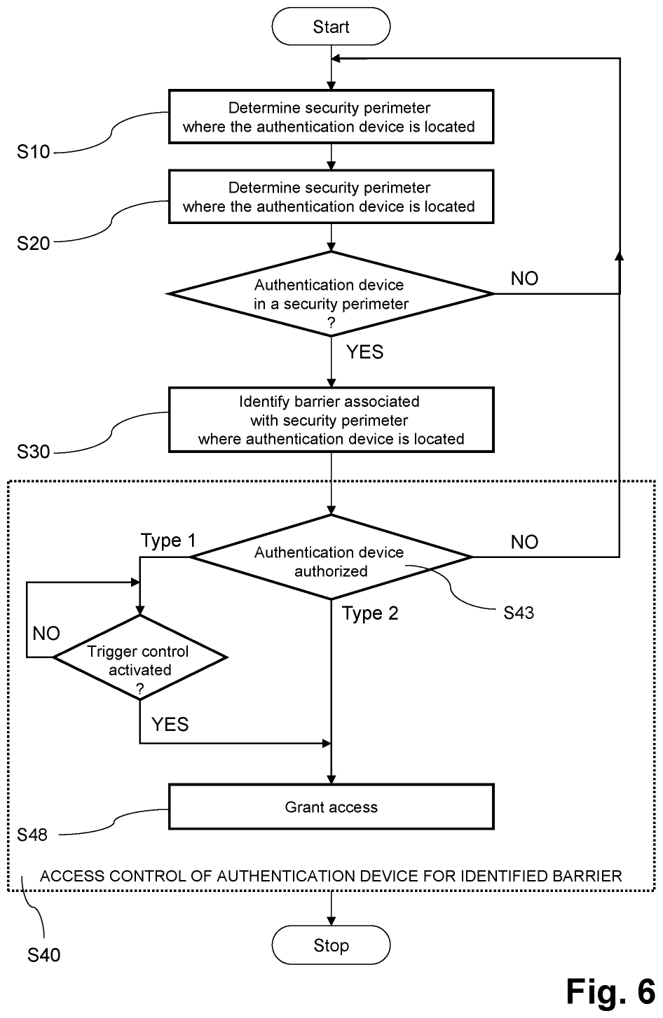

FIG. 6 shows a flow chart illustrating a sequence of steps of a further embodiment of a computer implemented method for controlling access within a secure control area A according to the present invention, wherein—in a step S43, a first-type and a second-type authorization is distinguished based on authentication data. In order to avoid accidental/inadvertent grant of access to an administrator of a secure control area A—who is frequently present in multiple security perimeters without the intention to gain access through each and every barrier, i.e. the authorization is of the first-type, access is granted only upon receipt of a trigger signal from a trigger control 7.1, 7.2, 7.3, 7.4 associated with the respective barrier(s) 5.1, 5.2, 5.3, 5.4. In order to provide convenience for guests/regular users—who have a clear intention to gain access through the barrier they are approaching, access is granted immediately (i.e. without further user interaction) if the authorization is of the second-type, irrespective of a trigger signal being received.

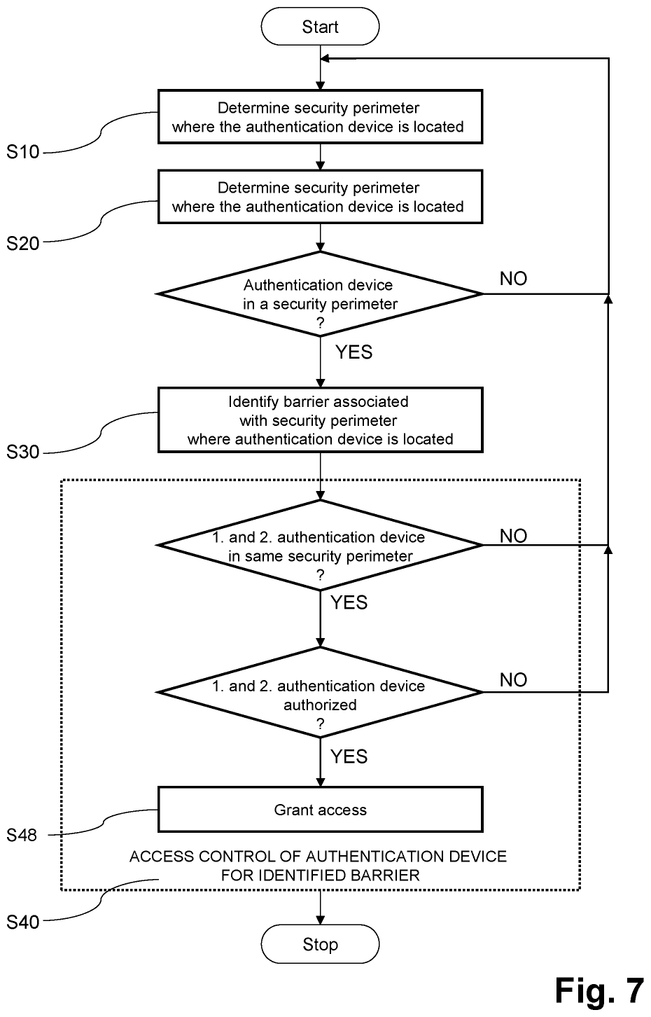

FIG. 7 shows a flow chart illustrating a sequence of steps of a further embodiment of a computer implemented method for controlling access within a secure control area A according to the present invention, wherein—in order to implement a four-eyes security policy—the access control process is executed only if a first authentication device 100 is within the same security perimeter I, II, III, IV as a second authentication device 100′, both first authentication device 100 and second authentication device 100′ being authorized.

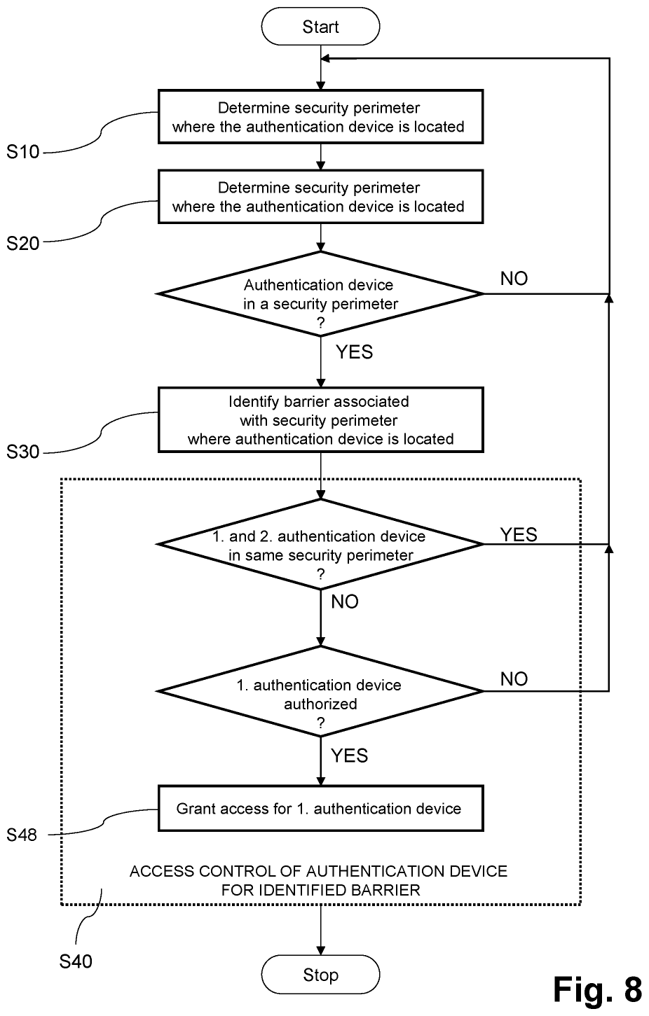

FIG. 8 shows a flow chart illustrating a sequence of steps of a further embodiment of a computer implemented method for controlling access within a secure control area A according to the present invention, wherein—in order to prevent so-called tailgating—access is only granted if no other authentication device 100 is located within the respective security perimeter I, II, III, IV.

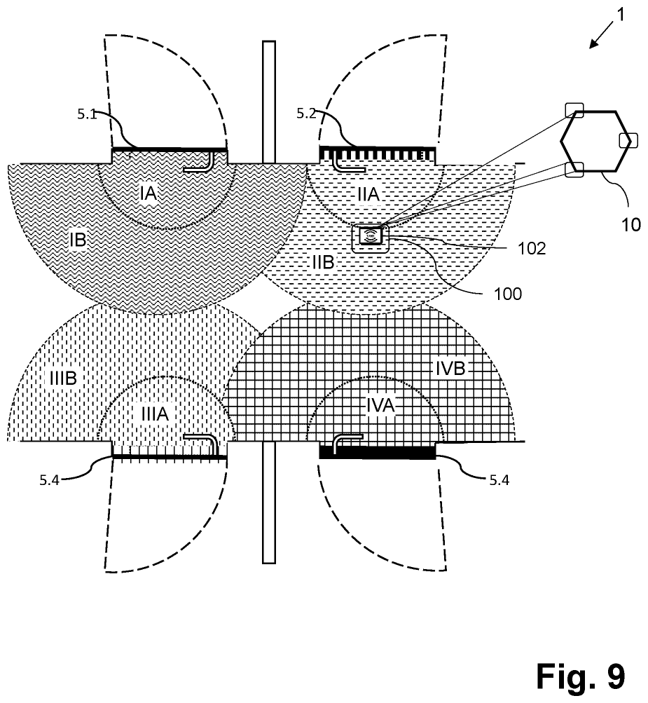

FIG. 9 shows a highly schematic top view of a further embodiment of the security control system 1 according to the present invention, aimed at combing security and convenience. As illustrated on FIG. 9, both a first security perimeter IA, IIA, IIIA, IVA and a second security perimeter IB, IIB, IIIB, IVB are associated with each of the barriers 5.1, 5.2, 5.3, 5.4 In particular, the first security perimeter IA, IIA, IIIA, IVA is smaller than a second security perimeter IB, IIB, IIIB, IVB. The first security perimeters IA, IIA, IIIA, IVA are defined for administrators of a secure control area A— who are frequently present in multiple security perimeters without the intention to gain access through each and every barrier. The second security perimeters IB, IIB, IIIB, IVB are defined for guests/regular users—who have a clear intention to gain access through the barrier they are approaching.

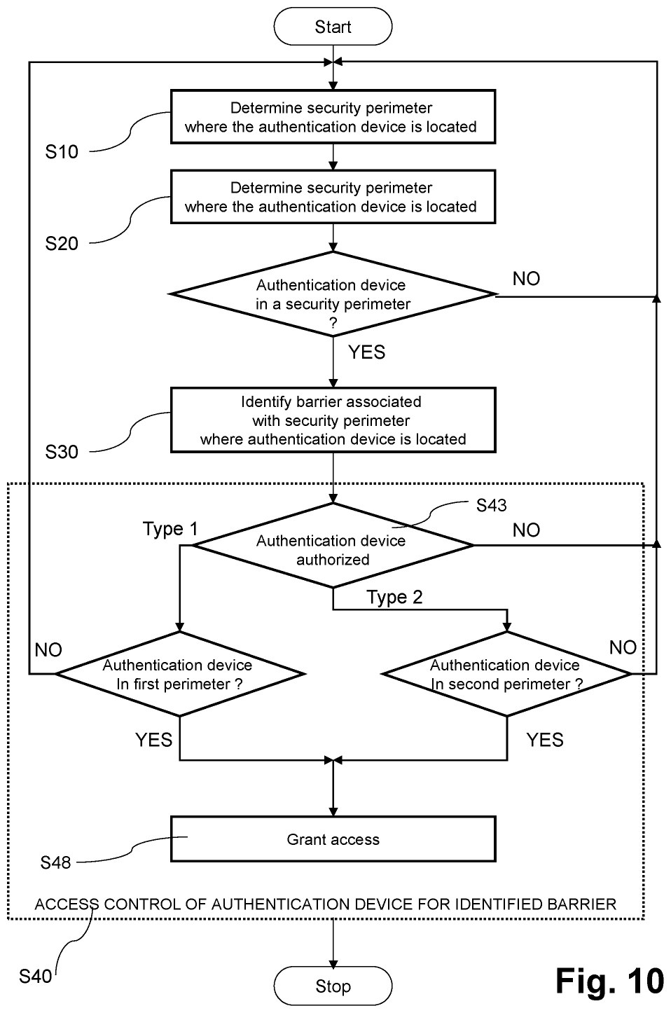

FIG. 10 shows a flow chart illustrating a sequence of steps of the method corresponding to the security control system 1 of FIG. 9. In order to avoid accidental/inadvertent access, if the authorization is of the first-type, access is granted using the barrier(s) 5.1, 5.2, 5.3, 5.4 only if the authentication device(s) 100, 100′ is/are located in the first security perimeter(s) IA, IIA, IIIA, IVA. In order to provide convenience, if the authorization is of the second-type, access is granted if the authentication device(s) 100, 100′ is/are located in the second security perimeter(s) IB, IIB, IIIB, IVB. As illustrated on FIG. 9, the second security perimeters IB, IIB, IIIB, IVB may even overlap. This does not pose a concern since users possessing authorization of the second-type are users who typically have authorization only with respect to one of the barrier(s) 5.1, 5.2, 5.3, 5.4 associated with one of the overlapping second security perimeters IB, IIB, IIIB, IVB.

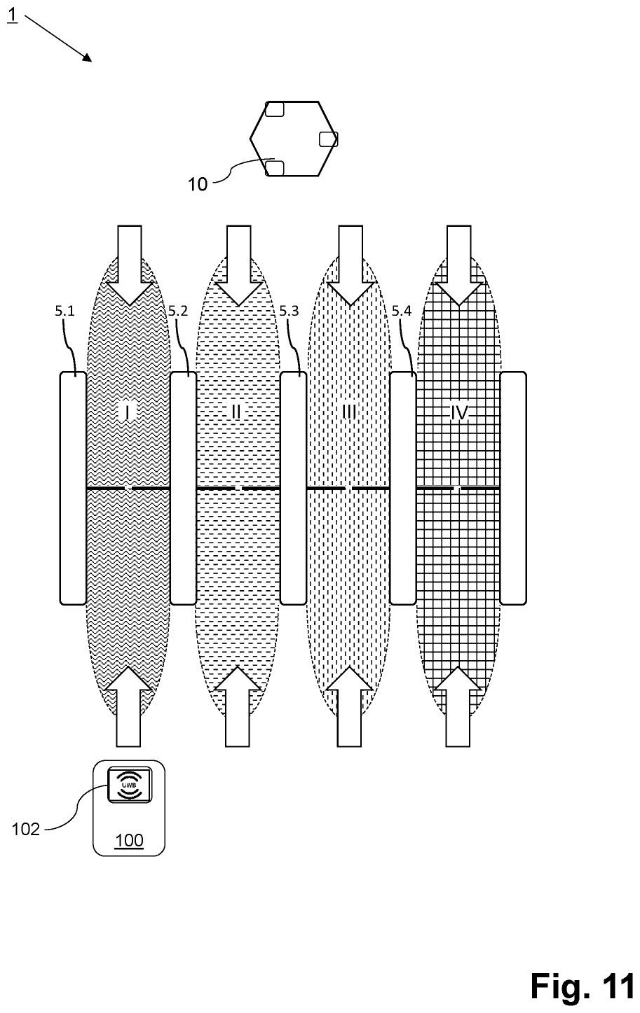

FIG. 11 shows a highly schematic top view of a security control system 1 according to the present invention as deployed in a secure control area A having a plurality of barriers 5.2, 5.3, 5.4, security perimeters I, II, III, IV being associated with the one or more barriers 5.1, 5.2, 5.3, 5.4, illustrating a use-case wherein the security perimeters I, II, III, IV are defined symmetrically with respect to the plurality of barriers 5.1, 5.2, 5.3, 5.4, allowing bi-directional access control.

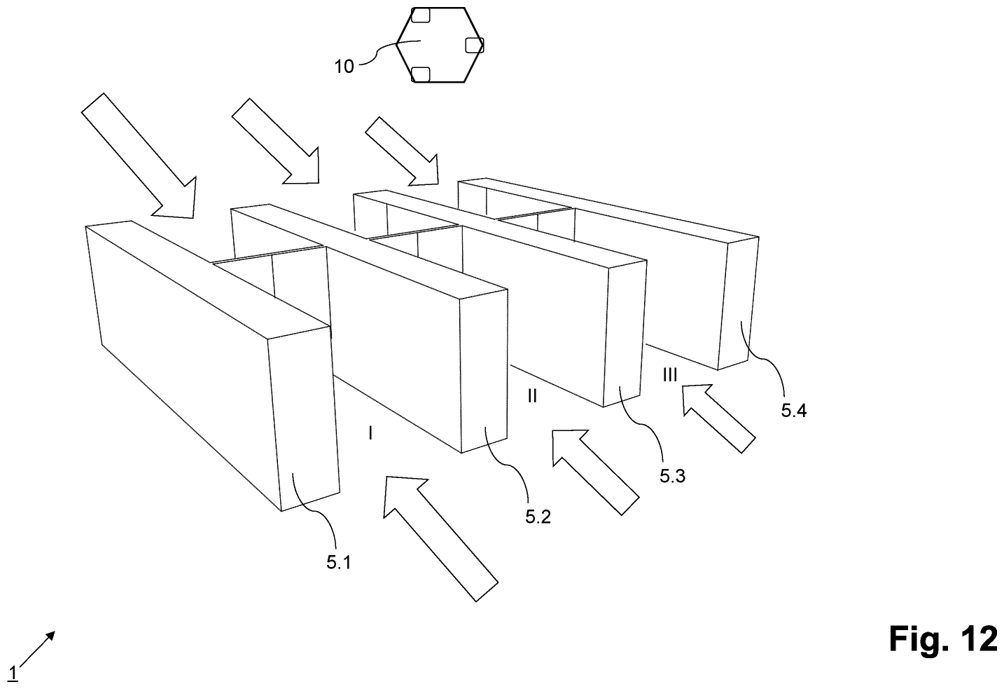

FIG. 12 shows a highly schematic perspective view of a security control system 1 according to the present invention as deployed in a secure control area A having waist-high passage gates as barriers 5.1, 5.2, 5.3, 5.4, security perimeters I, II, III, IV being associated with the one or more barriers 5.1, 5.2, 5.3, 5.4.

### LIST OF REFERENCE NUMERALS

security control system 1
barrier 5, 5.1, 5.2, 5.3, 5.4
trigger control 7, 7.1, 7.2, 7.3, 7.4
access control device 10
ultra-wideband transceiver 12
processing unit 14
communication module 16
authentication device 100, 100′
ultra-wideband communication module (of the authentication device) 102
secure control area A
security perimeters I, II, III, IV

1. An access control device for controlling access within a secure control area by means of one or more barriers, one or more security perimeters being associated with the one or more barriers the access control device comprising:
one or more ultra-wideband transceiver(s) configured to execute one or more ultra-wideband transmission(s) with one or more authentication device(s) and
a processing unit configured to:
determine physical location(s) of the authentication device(s) within the secure control area by processing signal properties of the one or more ultra-wideband transmission(s) and
determine the security perimeter(s) where the authentication device(s) is/are located based on the physical location(s),
the access control device being configured to execute an access control process(s) with respect to the barrier(s) associated with the security perimeter(s) where the authentication device(s) is/are located.

2. The access control device according to claim 1 for controlling access within a secure control area by means of a plurality of barriers, a plurality of security perimeters being associated with the plurality of barriers, wherein the processing unit is further configured to identify the barrier(s) from the plurality of barriers associated with the security perimeter(s) where the authentication device(s) is/are located.

3. The access control device according to claim 1, wherein the access control device is further configured to deny, disregard and/or block authentication requests from the authentication device(s) if the authentication device(s) is/are not located within one or more of the plurality of security perimeters.

4. The access control device according to claim 1, comprising a plurality of ultra-wideband transceivers each configured to execute one or more ultra-wideband transmission(s) with the authentication device(s), wherein the processing unit is configured to determine the physical location(s) of the authentication device(s) within the secure control area by multilateration and/or multiangulation using the plurality of ultra-wideband transmissions.

5. The access control device according to claim 1, wherein the processing of the signal properties comprises processing one or more of: a propagation time, an amplitude variation, or a phase difference of signals of the one or more ultra-wideband transmission(s).

6. The access control device according to claim 1, configured to execute the access control process(s) by:
receiving authentication data from the authentication device(s);
verifying the authentication data in order to determine whether the authentication device(s) is/are authorized access through the barrier(s) associated with the security perimeter(s) where the authentication device(s) is/are located; and
if the authentication device(s) is/are authorized, granting access using the barrier(s) associated with the security perimeter(s) where the authentication device(s) is/are located.

7. The access control device according to claim 6, configured to grant access only upon receipt of a trigger signal from a trigger control associated with the respective barrier(s).

8. The access control device according to claim 6, configured to grant access only after the one or more ultra-wideband transmission(s) with an authentication device has been maintained for longer than a threshold time period.

9. The access control device according to claim 6, further configured to:
distinguish, based on the authentication data, between a first-type and a second-type authorization; and
grant access only upon receipt of a trigger signal from a trigger control associated with the respective barrier(s) if the authorization is of the first-type;
grant access irrespective of a trigger signal being received if the authorization is of the second-type.

10. The access control device according to claim 6, for controlling access within a secure control area wherein a first security perimeter and a second security perimeter are associated with each of the one or more barriers, wherein the access control device is further configured to:
distinguish, based on the authentication data, between a first-type and a second-type authorization;
if the authorization is of the first-type, grant access using the barrier(s) associated with first security perimeter(s) (IA, IIA, IIIA, IVA) where the authentication device(s) is/are located;
if the authorization is of the second-type, grant access using the barrier(s) associated with second security perimeter(s) where the authentication device(s) is/are located.

11. The access control device according to claim 1, the one or more authentication device(s) comprising a first authentication device and a second authentication device, wherein the access control device is further configured to execute the access control process only if the first authentication device is within the same security perimeter as the second authentication device.

12. The access control device according to claim 1, the one or more authentication device(s) comprising a first authentication device and a second authentication device, wherein the access control device is further configured to deny, disregard and/or block authentication requests if the first authentication device is within the same security perimeter (I, II, III, IV) as the second authentication device.

13. The access control device according to claim 1, wherein the processing unit is configured to determine the physical location(s) of the authentication device(s) as 2-dimensional or 3-dimensional location(s), in particular as 2-dimensional or 3-dimensional coordinate(s), within the secure control area.

14. A computer implemented method for controlling access within a secure control area by means of one or more barriers communicatively connected to an access control device, one or more security perimeters being associated with the one or more barriers, the method comprising:
executing, using one or more ultra-wideband transceiver(s) of the access control device, one or more ultra-wideband transmission(s) with one or more authentication device(s); and
determining physical location(s) of the authentication device(s) within the secure control area by processing signal properties of the one or more ultra-wideband transmission(s);
determining the security perimeter(s) where the authentication device(s) is/are located based on the physical location(s);
executing an access control process(s) with respect to the barrier(s) associated with the security perimeter(s) where the authentication device(s) is/are located.

15. The computer implemented method according to claim 14 for controlling access within a secure control area by means of a plurality of barriers, a plurality of security perimeters being associated with the plurality of barriers, the method further comprising identifying the barrier(s) from the plurality of barriers associated with the security perimeter(s) where the authentication device(s) is/are located.

16. The computer implemented method according to claim 14 or further comprising denying, disregarding and/or blocking authentication requests from the authentication device(s) if the authentication device(s) is/are not located within one or more of the plurality of security perimeters.

17. The computer implemented method according to claim 14, the step of executing an access control process(s) comprising:
receiving authentication data from the authentication device(s);
verifying the authentication data in order to determine whether the authentication device(s) is/are authorized access through the barrier(s) associated with the security perimeter(s) where the authentication device(s) is/are located; and
if the authentication device(s) is/are authorized, granting access using the barrier(s) associated with the security perimeter(s) where the authentication device(s) is/are located.

18. The computer implemented method according to claim 17, further comprising:
receiving a trigger signal from a trigger control associated with the respective barrier(s); and
granting access using the barrier(s) upon receipt of the trigger signal.

19. The computer implemented method according to claim 17, further comprising:
distinguishing, based on the authentication data, between a first-type and a second-type authorization; and
granting access only upon receipt of a trigger signal from a trigger control associated with the respective barrier(s) if the authorization is of the first-type;
granting access irrespective of a trigger signal being received if the authorization is of the second-type.

20. The computer implemented method according to claim 17, for controlling access within a secure control area wherein a first security perimeter and a second security perimeter are associated with each of the one or more barriers, the method further comprising:
distinguishing, based on the authentication data, between a first-type and a second-type authorization;
if the authorization is of the first-type, granting access using the barrier(s) associated with first security perimeter(s) where the authentication device(s) is/are located;
if the authorization is of the second-type, granting access using the barrier(s) associated with second security perimeter(s) where the authentication device(s) is/are located.

21. The computer implemented method according to claim 14, wherein the one or more authentication device(s) comprising a first authentication device and a second authentication device, the method comprising executing the access control process only if the first authentication device is within the same security perimeter as the second authentication device.

22. The computer implemented method according to claim 14, wherein the one or more authentication device(s) comprising a first authentication device and a second authentication device, the method comprising denying, disregarding and/or blocking authentication requests if the first authentication device is within the same security perimeter as the second authentication device.

23. A computer program product comprising computer-executable instructions which, when executed by a processing unit of an access control device, causes the access control device to carry out a method for controlling access comprising:
executing, using one or more ultra-wideband transceiver(s) of the access control device, one or more ultra-wideband transmission(s) with one or more authentication device(s); and
determining physical location(s) of the authentication device(s) within a secure control area by processing signal properties of the one or more ultra-wideband transmission(s);
determining a security perimeter(s) where the authentication device(s) is/are located based on the physical location(s);
executing an access control process(s) with respect to one or more barrier(s) associated with the security perimeter(s) where the authentication device(s) is/are located.

24. A security control system comprising:
one or more barriers arranged within a secure control area;
one or more security perimeters being associated with the one or more barriers; and
an access control device comprising,
one or more ultra-wideband transceiver(s) configured to execute one or more ultra-wideband transmission(s) with one or more authentication device(s), and
a processing unit configured to:
determine physical location(s) of the authentication device(s) within the secure control area by processing signal properties of the one or more ultra-wideband transmission(s),
determine the security perimeter(s) where the authentication device(s) is/are located based on the physical location(s), and
execute an access control process with respect to the barrier(s) associated with the security perimeter(s) where the authentication device(s) is/are located.
